(19) United States
(12) Patent Application Publication
(10) Pub. No.: US 2006/0077441 A1
(43) Pub. Date: Apr. 13, 2006

(54) Distribution system for developing and delivering photographs

(76) Inventor: John C. Manzolillo, Baltimore, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/232,947

(22) Filed: Sep. 23, 2005

Related U.S. Application Data
(60) Provisional application No. 60/612,557, filed on Sep. 23, 2004.

(51) Int. Cl. G06F 3/12

(52) U.S. Cl. 358/1.15; 358/402; 358/403

(57) ABSTRACT

Methods, systems, and computer program products for delivering a hard copy print of a captured image are disclosed. A photo medium containing a captured image and a recipient address are received. A photofinishing location is selected based on the recipient address. Electronic data representing the photo medium is sent to a photofinisher associated with the photofinishing location. A photofinisher produces a hard copy print from the electronic data. The photographic print is delivered to a recipient at the recipient address.

### RELATED APPLICATIONS

This application claims the benefit of the filing date of U.S. Provisional Application No. 60/612,557, filed Sep. 23, 2004, titled “Distribution System for Developing and Delivering Photographs,” by John C. Manzolillo, incorporated in its entirety herein by reference.

### TECHNICAL FIELD

This disclosure is directed to the field of photograph delivery, and more particularly, to the field of distributed printing and delivery of hard copy photographs.

### BACKGROUND

Every day, individuals, companies and other consumers seek to process, print, and send hard copy photographs. Fast delivery of photographs is very desirable. Processing, printing, and sending the photographs, however, typically includes many time-consuming steps.

When film is the picture-taking medium, the steps typically include: locating a local film developing center, taking the film to the developing center, waiting for development, printing from the negatives, receiving the printed photographs, choosing which photographs to send, and delivering the photographs to the recipient. When the picture-taking medium is digital, photographers may encounter similar time-consuming obstacles, such as: locating a web-enabled receiver and printer, uploading the digital images, selecting which images to print, printing the photographs, and delivering the photographs to a recipient. In both instances, if the recipient is located far from the sender, the process may include additional time-consuming steps related to delivery, such as: packaging the photographs for delivery, paying correct delivery fees for the package, taking the package to a delivery service, such as the United States Postal Service, and transporting the package to the recipient, who may be hundreds or thousands of miles away.

To obtain a good print of their photograph, owners of digital cameras, photo-enabled cell phones, or web-enabled photo devices must locate high-quality printers to produce hard copies. Photo processing centers may offer production of quality hard copy photographs. However, local photo processing centers often do not offer integrated packaging and delivery services.

Photographers may use distributed print production companies to deliver hard copy photographs to recipients who are miles away from a photograph developer or photograph printing facility. However, one disadvantage of current distributed print production systems is that they require photograph development and printing at facilities located far from distribution facilities. Once the photographs are printed, they must be sent to a distribution facility for delivery. At the distribution facility, the packages must be created, labeled, and shipped. This process may cause delays of several days, as well as added expense and frustration for the consumer.

Another drawback of conventional print production systems is the expense caused by the long-distance delivery charges needed to ship the photographs to the many recipients who are not local to the photo processing center.

Yet another drawback of current print production systems is their inability to handle film. It is therefore desirable to improve the delivery of finished, hard copies of photographs and provide faster and more convenient processing and distribution for consumers.

### SUMMARY

Consistent with one aspect of the present invention, a method of delivering a hard copy print of a captured image comprises receiving from a customer a photo medium containing a captured image, receiving a recipient address, selecting a photofinishing location based on the recipient address, sending electronic data representing the captured image to a photofinisher associated with the photofinishing location, producing, by the photofinisher, a hard copy print from the electronic data, and causing delivery of the print to a recipient at the recipient address.

Consistent with another aspect of the invention, a system for delivering a hard copy print of a captured image comprises a processing portal comprising a receiver configured to receive a recipient address and a photo medium containing a captured image, a selector configured to select a photofinishing location based on the recipient address, a sender configured to send electronic data representing the captured image to a photofinisher associated with the photofinishing location, and a photofinisher associated with the photofinishing location, the photofinisher comprising a printer configured to produce a hard copy print from the electronic data, and a delivery component configured to cause delivery of the print to a recipient at the recipient address.

Consistent with another aspect of the invention, a system for delivering a hard copy print of a captured image comprises means for receiving from a customer a photo medium containing a captured image, means for receiving a recipient address, means for selecting a photofinishing location based on the recipient address, means for sending electronic data representing the captured image to a photofinisher associated with the photofinishing location, means for producing a hard copy print from the electronic data, and means for causing the delivery of the print to a recipient at the recipient address.

Consistent with another aspect of the invention, a computer-readable medium includes instructions for performing a method of delivering a hard copy print of a captured image, the method comprising receiving from a customer a photo medium containing a captured image, receiving a recipient address, selecting a photofinishing location based on the recipient address, sending electronic data representing the captured image to a photofinisher associated with the photofinishing location, producing, by the photofinisher, a hard copy print from the electronic data, and causing the delivery of the hard copy print to a recipient at the recipient address.

Advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings,

FIG. 1 is a diagram of the components in an exemplary distribution system for developing and delivering photographs consistent with the present invention;

FIG. 2 is a diagram of an exemplary photofinisher within a distribution system for developing and delivering photographs consistent with the present invention;

FIG. 3 is a diagram of an exemplary processing portal within a distribution system for developing and delivering photographs consistent with the present invention;

FIG. 4 is a flow diagram of exemplary steps performed by the distribution system to develop and deliver photographs consistent with the present invention;

FIG. 5 is a flow diagram of exemplary steps performed by the processing portal and photofinisher to develop, scan, print, and send photographs consistent with the present invention;

FIG. 6 is a flow diagram of exemplary steps performed by the photofinisher to calculate charges, pay, and transmit electronic shipping files consistent with the present invention; and

FIG. 7 is an exemplary computing system consistent with embodiments of the invention.

### DETAILED DESCRIPTION

Reference will now be made in detail to exemplary embodiments of the invention, examples of which are illustrated in the accompanying drawings. Wherever convenient, the same reference numbers will be used throughout the drawings to refer to the same or like parts.

Photofinishing companies need to be able to print photographs for customers and send those photographic prints to recipients in a timely manner. Distributed print production allows picture processing to be integrated with a delivery company's local delivery zones. The effect is to offer same-day and next-day delivery of high-quality hard copy photographs to recipients who can be literally thousands of miles and many time zones distant from where the photos were taken.

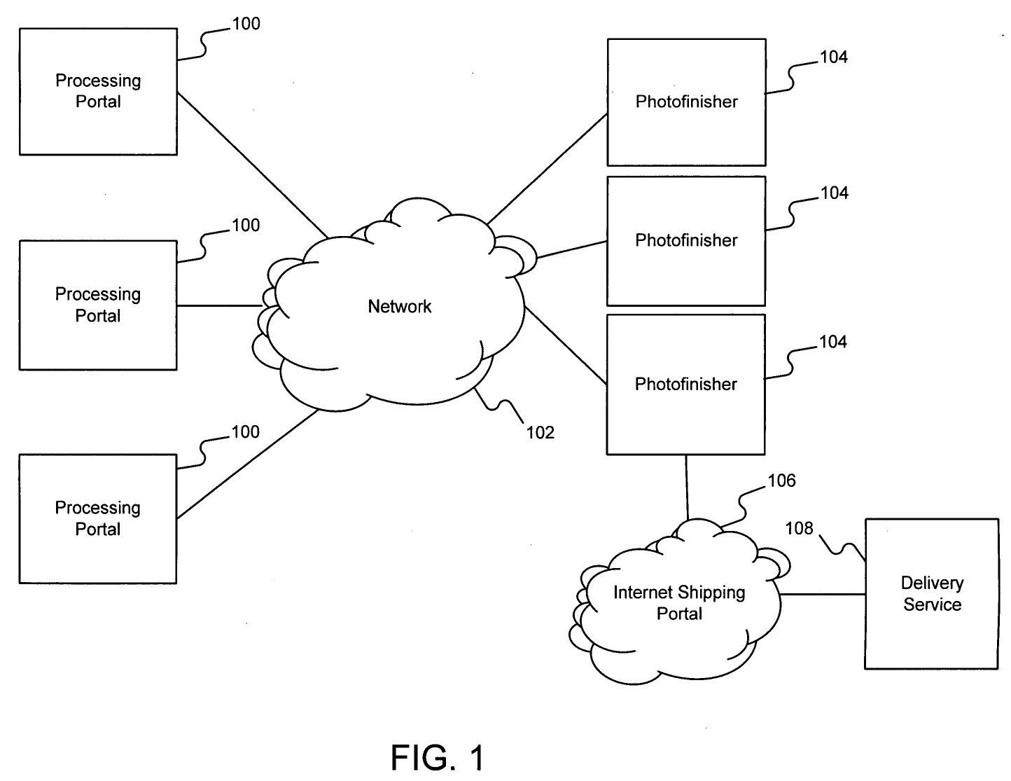

FIG. 1 illustrates a system 10 consistent with the present invention. One or more processing portals 100 and one or more photofinishers 104 (which may be geographically diverse) are connected in a network configuration represented by a network cloud 102. Photofinishers 104 communicate with a delivery service 108 using an internet shipping portal 106. The composition and protocol of the network configuration represented in FIG. 1 is not important as long as it allows for communication of information between a processing portal 100 and any of photofinishers 104.

A large number of geographically dispersed photofinishers 104 allows fast, local delivery of photographic prints to nearby designated recipients. In addition, the use of three processing portals and photofinishers is merely for illustration and does not limit the present invention to the use of a particular number of processing portals or photofinishers. The input to the processing portal may be digital-based or chemical-film-based media. The output may be hard copy photographic prints. The output is not dependent on the recipient having access to a web-enabled receiver and printer.

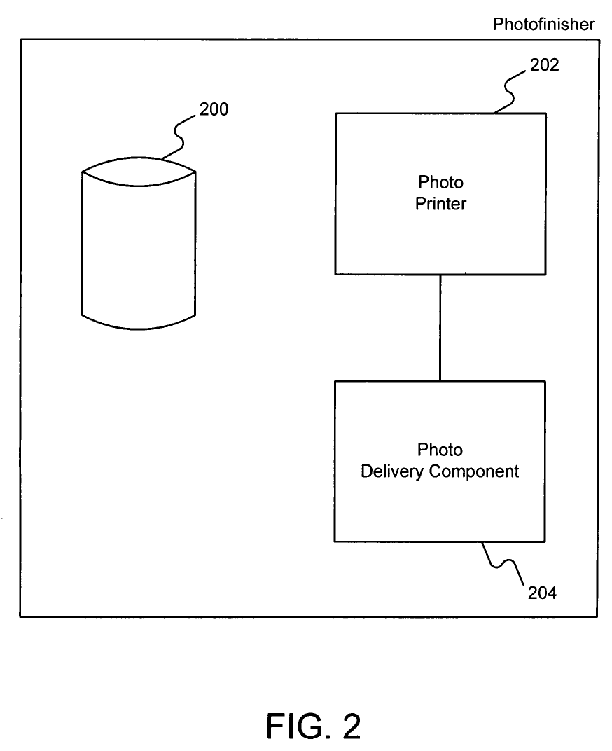

FIG. 2 is a diagram of the components of a photofinisher 104 consistent with an implementation of the present invention. A photofinisher 104 may be any processing facility that can receive electronic transmissions of customer photo orders. A photofinisher 104 may include a database 200, a photo printer 202, and a photo delivery component 204. Database 200 may store processing instructions associated with a received photo(s). The processing instructions may include, for example, a selection of images to print, or image editing directions, such as how to crop, frame, or rotate an image. In one embodiment, database 200 may store requests for specific dimensions of a photographic print and color or black and white selections. In another embodiment, database 200 may store data related to a customer or recipient, such as prior orders, recipient addresses, and special instructions for storage and delivery.

Photo printer 202 is configured to produce a photographic print. In one embodiment, photo printer 202 is configured to produce a photographic print based on the processing instructions stored in database 200. A photo delivery component 204 is configured to produce an electronic shipping file including package detail. The package detail may include several types of information. In one embodiment, the package detail includes a package identification number. In another embodiment, the package detail includes a barcode based on a recipient address.

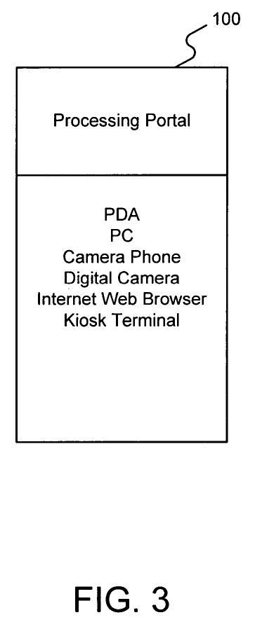

FIG. 3 is a diagram of a processing portal 100 consistent with an implementation of the present invention. In one embodiment, processing portal 100 is a kiosk terminal. In another embodiment, processing portal 100 is an internet web browser. In another embodiment, processing portal 100 is a local server design to handle file transmissions. In each instance, processing portal 100 may receive uploaded electronic data from a camera phone, digital camera, personal digital assistant (PDA), personal computer (PC), and other digital photography communication devices. Additionally, processing portal 100 may also accept film, and may include a camera store, or kiosk terminal.

In one embodiment, processing portal 100 is configured to receive payment required for processing, packaging, and/or delivery services. For example, an internet web browser may accept credit card payment for processing file transmissions and shipping fees. In another example, a kiosk terminal-may accept cash payment for delivery services.

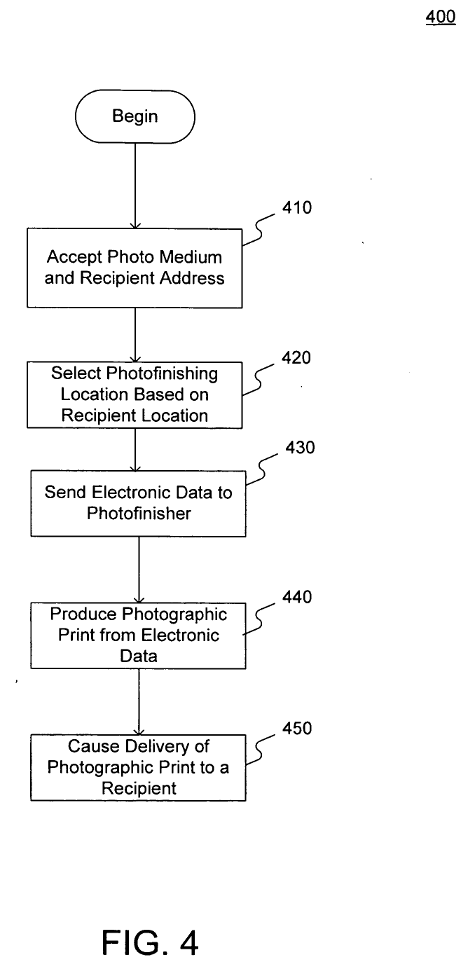

A method 400 for delivering a hard copy photographic print is illustrated in FIG. 4. As shown, processing portal 100 receives a photo medium and a recipient address from a customer (step 410). The photo medium may be film or a digital memory device containing electronic data representing an image, such as an SD card. In addition to ordering prints for himself, the customer may order sets of prints to be delivered to friends and family across the country, or even internationally. In one embodiment, the method may including processing instructions from the customer. Depending on the application, various steps of the method may be performed either by processing portal 100 or photofinisher 104.

Based on the recipient address, a photofinishing location is selected (step 420). The photofinishing location may be selected in various ways. In one example, the customer may select the photofinishing location closest to the recipient address, based on the town, city, state, region, postal code, or country of the recipient address. In another example, the customer may choose the photofinishing location from a list of specified sites corresponding to the recipient address.

Processing portal 100 sends electronic data representing the image to a photofinisher associated with the photofinishing location (step 430). In the case of a digital photo, the electronic data may be read from the photo medium itself. In the case of film medium, the electronic data is generated by scanning the film, a negative, or a print. Photofinisher 104 produces a photographic print from the electronic data (step 440). Photofinisher 104 causes delivery of the photographic print to a recipient at the recipient address (step 450).

In one exemplary embodiment, a customer may take a pictures with a digital camera. The customer may designate the recipients, upload the electronic data from the digital camera via a home PC to a photofinisher company's website that afternoon, and pay for the order via credit card. The photofinisher company may verify the credit card information and distribute the files via its intranet or extranet to the photofinisher print production sites nearest to the designated recipients. The customer may specify same day or next day delivery to the recipient.

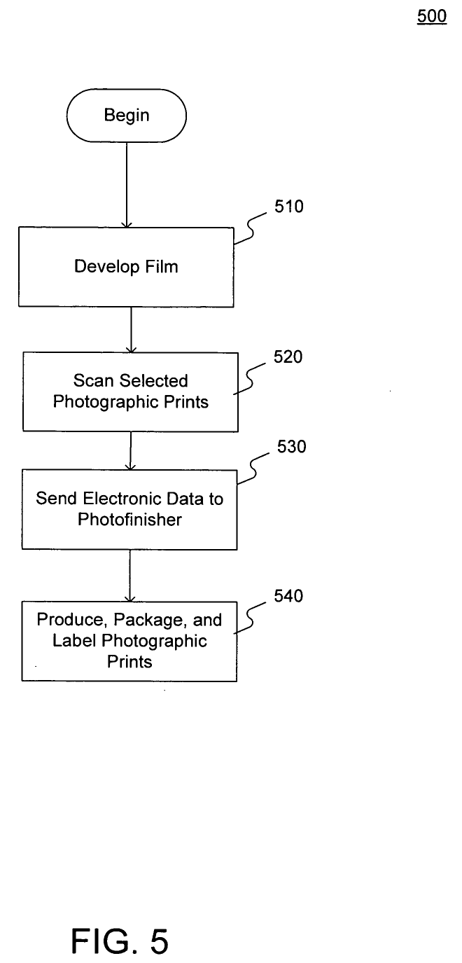

In another exemplary embodiment, illustrated in FIG. 5, a customer takes photographs using a traditional film camera and drops off the exposed film at a picture processing center. Processing portal 100 and photofinisher 104 perform the steps of a procedure 500 that may be used to deliver a photographic print where the photo medium is film. The picture processing center develops the film, if necessary (step 510), prints the images captured on the film, and scans any prints the customer has selected to transmit to generate the data (step 520). Electronic data representing the captured images are transmitted electronically via a network to a photofinisher in a location closest to a recipient address specified by the customer (step 530). Prints of the captured images are produced, packaged, and labeled for delivery at the photofinisher (step 540).

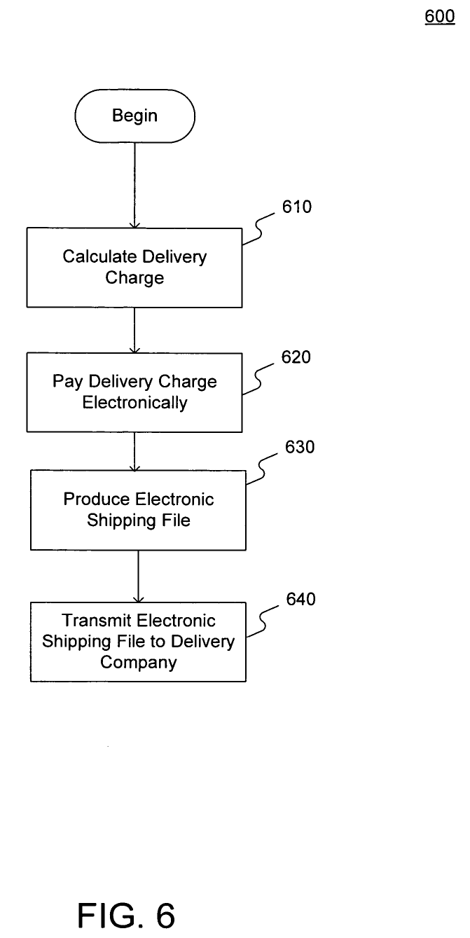

In another exemplary embodiment shown in FIG. 6, a photofinisher may calculate a delivery charge using an internet-based shipping application for postage or delivery payment (step 610). A photofinisher 104 performs the steps of procedure 600 illustrated in FIG. 6. Photofinisher 104 pays the delivery charge electronically on behalf of the customer (step 620), and produces an electronic shipping file (step 630). The electronic shipping file may include package-level detail, such as a unique package identification number or barcode. Photofinisher 104 transmits the electronic shipping file to the delivery company for delivery service (step 640). Photofinisher 104 may transmit the electronic shipping file within a time frame specified by the customer. The delivery company effects delivery of the packages and records the delivery information. When the delivery service uses an internet-based shipping information application, the delivery company transmits the delivery information via its systems back to the customer and photofinisher.

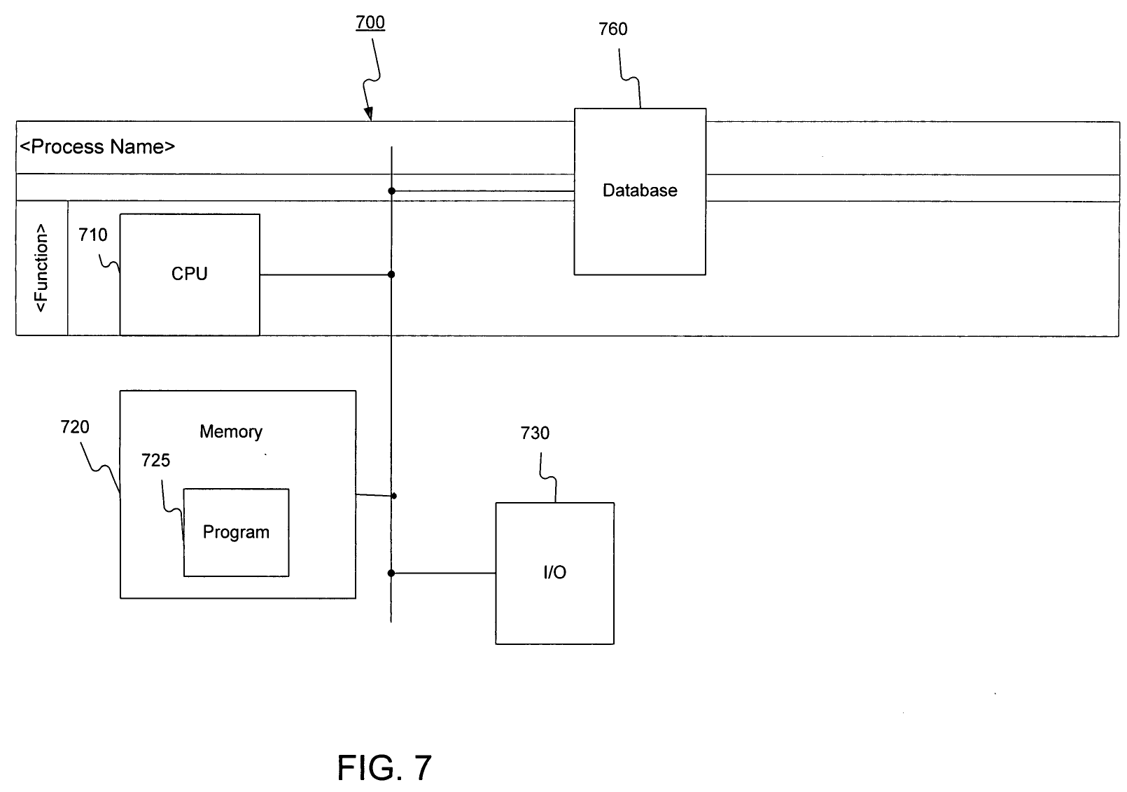

FIG. 7 illustrates an exemplary computing system 700 consistent with embodiments of the invention. The specific components and arrangement, however, are not critical to the present invention.

System 700 includes a number of components, such as a central processing unit (CPU) 710, a memory 720, an input/output (I/O) device(s) 730, and a database 760, which can be implemented in various ways. For example, an integrated platform (such as a workstation, personal computer, laptop, etc.) may comprise CPU 710, memory 720 and I/O devices 730. In such a configuration, components 710, 720, and 730 may connect through a local bus interface. Access to database 760 (implemented as a separate database system) may be facilitated through a direct communication link, a local area network (LAN), a wide area network (WAN) and/or other suitable connections. System 700 may be part of a larger photo-finishing and delivery system that networks several similar systems to perform processes and operations consistent with the invention.

CPU 710 may be one or more known processing devices, such as a microprocessor from the Pentium™ family manufactured by Intel™. Memory 720 may be one or more storage devices configured to store information used by CPU 710 to perform certain functions related to embodiments of the present invention. Memory 720 may be a magnetic, semiconductor, tape, optical, or other type of storage device. In one embodiment consistent with the invention, memory 720 includes one or more programs 725 that, when executed by CPU 710, perform processes and operations consistent with the present invention. For example, memory 720 may include a program 725 that accepts and processes digital photographs, or memory 720 may include a photofinishing selection program 725, or memory 720 may include delivery charge program 725, or a film processing and scanning program 725.

Methods, systems, and articles of manufacture consistent with the present invention are not limited to programs or computers configured to perform dedicated tasks. For example, memory 720 may be configured with a program 725 that performs several functions when executed by CPU 710.- That is, memory 720 may include a program(s) 725 that perform photofinishing functions, delivery functions, digital photo processing functions, film processing functions, and other functions, such as an accounting functions that keep the books of a photo-finishing organization and process business data. Alternatively, CPU 710 may execute one or more programs located remotely from system 700. For example, system 700 may access one or more remote programs that, when executed, perform functions related to embodiments of the present invention.

Memory 720 may be also be configured with an operating system (not shown) that performs several functions well known in the art when executed by CPU 710. By way of example, the operating system may be Microsoft Windows™, Unix™, Linux™, an Apple Computers operating system, Personal Digital Assistant operating system such as Microsoft CE™, or other operating system. The choice of operating system, and even to the use of an operating system, is not critical to the invention.

I/O device(s) 730 may comprise one or more input/output devices that allow data to be received and/or transmitted by system 700. For example, I/O device 730 may include one or more input devices, such as a keyboard, touch screen, mouse, scanner, communications port, and the like, that enable data to be input from a user. Further, I/O device 730 may include one or more output devices, such as a display screen, CRT monitor, LCD monitor, plasma display, printer, speaker devices, communications port, and the like, that enable data to be output or presented to a user. The configuration and number of input and/or output devices incorporated in I/O device 730 are not critical to the invention.

Database 760 may comprise one or more databases that store information and are accessed and/or managed through system 700. By way of example, database 760 may be an Oracle™ database, a Sybase™ database, or other relational database, or database 760 may be part of an ERP system. Systems and methods of the present invention, however, are not limited to separate databases or even to the use of a database, as data can come from practically any source, such as the internet and other organized collections of data.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of delivering a hard copy print of a captured image, comprising:
receiving from a customer a photo medium containing a captured image;
receiving a recipient address;
selecting a photofinishing location based on the recipient address;
sending electronic data representing the captured image to a photofinisher associated with the photofinishing location;
producing, by the photofinisher, a hard copy print from the electronic data; and
causing delivery of the print to a recipient at the recipient address.

2. The method of claim 1, wherein selecting the photofinishing location comprises:
selecting the photofinishing location closest to the recipient address.

3. The method of claim 1, wherein selecting the photofinishing location comprises:
selecting the photofinishing location from which a hard copy print can be delivered to the recipient address within 24 hours.

4. The method of claim 2, wherein selecting the photofinishing location closest to the recipient address is determined based on a postal code.

5. The method of claim 2, wherein selecting the photofinishing location closest to the recipient address is determined based on a city of the recipient address.

6. The method of claim 2, wherein selecting the photofinishing location closest to the recipient address is determined based on a state of the recipient address.

7. The method of claim 2, wherein selecting the photofinishing location closest to the recipient address comprises:
selecting the photofinishing location from a list of specified sites corresponding to the recipient address.

8. The method of claim 2, wherein selecting the photofinishing location closest to the recipient address comprises:
receiving a selection of a photofinishing location by the customer.

9. The method of claim 1, wherein causing the delivery of the print to a recipient at the recipient address comprises:
calculating a delivery charge for the print using an internet-based shipping application;
paying the delivery charge on behalf of the customer;
producing an electronic shipping file; and
transmitting the electronic shipping file to a delivery service.

10. The method of claim 9, further comprising:
receiving payment for the delivery charge.

11. The method of claim 1, further comprising:
storing processing instructions for the photo medium.

12. The method of claim 1, wherein the photo medium comprises:
a digital memory device.

13. The method of claim 1, wherein the photo medium comprises:
photographic film.

14. The method of claim 1, wherein receiving from a customer a photo medium containing captured images includes:
receiving from a camera phone electronic data representing a captured image.

15. The method of claim 1, wherein receiving from a customer a photo medium containing captured images includes:
receiving from a portable wireless device electronic data representing a captured image.

16. A system for delivering a hard copy print of a captured image, comprising:
a processing portal comprising:
a receiver configured to receive a recipient address and a photo medium containing a captured image;
a selector configured to select a photofinishing location based on the recipient address;
a sender configured to send electronic data representing the captured image to a photofinisher associated with the photofinishing location; and
a photofinisher associated with the photofinishing location, the photofinisher comprising:
a printer configured to produce a hard copy print from the electronic data; and
a delivery component configured to cause delivery of the print to a recipient at the recipient address.

17. The system of claim 16, wherein the processing portal further comprises a delivery processor, the delivery processor being configured to:
calculate a delivery charge for the print using an internet-based shipping application;
pay the delivery charge on behalf of the customer;
produce an electronic shipping file; and
transmit the electronic shipping file to a delivery service.

18. The system of claim 16, wherein the processing portal further comprises:
a payment receiver configured to receive payment for the delivery charge.

19. The system of claim 16, further comprising:
a database configured to store processing instructions for the captured image.

20. The system of claim 16, wherein the receiver comprises:
a camera phone receiver configured to accept, from a camera phone, electronic data representing a captured image.

21. The method of claim 16, wherein the receiver comprises:
a portable device receiver configured to accept, from a portable wireless device, electronic data representing a captured image.

22. The system of claim 16, wherein the photo medium comprises:
a digital memory device.

23. The system of claim 16, wherein the photo medium comprises:
photographic film.

24. A system for delivering a hard copy print of a captured image, comprising:
means for receiving from a customer a photo medium containing a captured image;
means for receiving a recipient address;
means for selecting a photofinishing location based on the recipient address;
means for sending electronic data representing the captured image to a photofinisher associated with the photofinishing location;
means for producing a hard copy print from the electronic data; and
means for causing the delivery of the print to a recipient at the recipient address.

25. The system of claim 24, wherein the means for receiving from a customer a photo medium containing a captured image comprises:
an internet web browser.

26. The system of claim 24, wherein the means for receiving from a customer a photo medium containing a captured image comprises:
a kiosk terminal.

27. The system of claim 24, wherein the means for receiving from a customer a photo medium containing a captured image comprises:
a physical drop off location.

28. The system of claim 24, wherein the means for receiving from a customer a photo medium containing a captured image further comprises:
means for receiving, from a camera phone, electronic data representing a captured image.

29. The system of claim 24, wherein the means for receiving from a customer a photo medium containing a captured image further comprises:
means for receiving from a portable wireless device, electronic data representing a captured image.

30. The system of claim 24, wherein the photo medium comprises:
a digital memory device.

31. The system of claim 24, wherein the photo medium comprises:
photographic film.

32. A computer-readable medium including instructions for performing a method of delivering a hard copy print of a captured image, the method comprising:
receiving from a customer a photo medium containing a captured image;
receiving a recipient address;
selecting a photofinishing location based on the recipient address;
sending electronic data representing the captured image to a photofinisher associated with the photofinishing location;
producing, by the photofinisher, a hard copy print from the electronic data; and
causing the delivery of the hard copy print to a recipient at the recipient address.

33. The computer-readable medium of claim 32, wherein selecting the photofinishing location comprises:
selecting the photofinishing location closest to the recipient address.

34. The computer-readable medium of claim 32, wherein selecting the photofinishing location comprises:
selecting the photofinishing location from which a hard copy print can be delivered to the recipient address within 24 hours.

35. The computer-readable medium of claim 33, wherein selecting the photofinishing location closest to the recipient address is determined based on a postal code.

36. The computer-readable medium of claim 33, wherein selecting the photofinishing location closest to the recipient address is determined based on a city of the recipient address.

37. The computer-readable medium of claim 33, wherein selecting the photofinishing location closest to the recipient address is determined based on a state of the recipient address.

38. The computer-readable medium of claim 33, wherein selecting the photofinishing location closest to the recipient address comprises:
selecting the photofinishing location from a list of specified sites corresponding to the recipient address.

39. The computer-readable medium of claim 33, wherein selecting the photofinishing location closest to the recipient address comprises:
receiving a selection of a photofinishing location from the customer.

40. The computer-readable medium of claim 32, wherein the method further includes:
calculating a delivery charge for the print using an internet-based shipping application;
paying the delivery charge on behalf of the customer;
producing an electronic shipping file; and
transmitting the electronic shipping file to a delivery service.

41. The computer-readable medium of claim 40, wherein the method further comprises:
receiving payment for the delivery charge.

42. The computer-readable medium of claim 32, wherein the method further comprises:
storing processing instructions for the captured image.

43. The computer-readable medium of claim 32, wherein the photo medium comprises:
a digital memory device.

44. The computer-readable medium of claim 32, wherein the photo medium comprises:
photographic film.

45. The method of claim 32, wherein receiving from a customer a photo medium containing a captured image includes:
receiving from a camera phone electronic data representing a captured image.

46. The method of claim 32, wherein receiving from a customer a photo medium containing a captured image includes:
receiving from a portable wireless device electronic data representing a captured image.
